(19) United States
(12) Patent Application Publication
(10) Pub. No.: US 2001/0023882 A1
(43) Pub. Date: Sep. 27, 2001

(54) Tape dispenser

(76) Inventor: Barry Francis Gilkes, Moreton in March (GB)

Correspondence Address: PEDERSEN & COMPANY, PLLC, P.O. BOX 2666, BOISE, ID, 83701, US

(21) Appl. No.: 09/816,949

(22) Filed: Mar. 22, 2001

(30) Foreign Application Priority Data
Mar. 22, 2000 (GB) 0006804.9

(51) Int. Cl. B26D 3/02

(52) U.S. Cl. 225/26; 225/39

(57) ABSTRACT

This invention relates to a tape dispenser, and in particular to a tape dispenser for use in binding horticultural produce and the like. According to a first aspect of the invention there is provided a tape dispenser having a housing adapted to locate a spool of tape, the housing having an opening through which the tape can pass and blade means for cutting the tape, the housing being formed from separable housing parts which are retained together by a removable handle. According to a second aspect of the invention there is provided a tape dispenser having a housing adapted to locate a spool of tape, and a handle connected to the housing, the housing having an opening through which tape can pass and blade means for cutting the tape, the housing being substantially waterproof.

This application claims priority, under 35 U.S.C. 119, of GB Patent Application 0006804.9, filed Mar. 22, 2000.

### FIELD OF THE INVENTION

This invention relates to a tape dispenser, and in particular to a tape dispenser for use in binding horticultural produce and the like, and/or in binding the packaging sacks containing such produce.

### BACKGROUND TO THE INVENTION

Horticultural produce such as onions, carrots and the like, and other articles such as flowers, are usually harvested individually in the field and yet are sold in bunches, bundles or packs. The articles may be bound together in such a way that they are maintained together until sold to the eventual customer; alternatively, the articles may be packed into bags or sacks.

Often, produce will be bundled in the field, and it is particularly desirable to do this whenever possible as the produce can then be taken to market promptly, ensuring that the produce is a fresh as possible. Sometimes however, and in particular for certain produce which requires washing or other preparation prior to bundling, it will be bundled in a pack house located away from the field. For example, onions which are in prime state can be bundled in the field, yet onions which have passed their prime state will require the removal of some of the external leaves, which procedure can best be carried out in the pack house. Produce which requires washing will also typically be bundled in a pack house.

Produce such as potatoes can be loaded into sacks in the field, and the sacks closed in the field.

### DESCRIPTION OF THE PRIOR ART

Several means of maintaining produce in bundles are known, one of the most common being the use of elastic bands of rubber or the like. Such elastic bands can be used both in the field and in the pack house. However, it is a known problem with the use of such bands that large numbers become discarded as they are dropped by the user, e.g. a user seeking to take one band from a box might inadvertently take more than one, the surplus band or bands being dropped onto the ground or floor from where they are seldom if ever retrieved. When the bands are used in a field, there can be a particular concern for a farmer if he subsequently has animals grazing on a field in which elastic bands have been dropped, as it is known that in muddy conditions the bands can become forced over the foot of a sheep or deer for example, the band subsequently restricting the blood flow to the animal's foot; despite the low probability of this occurring it is neverthless a recognised problem in view of the large number of bands which are dropped.

In addition, the large wastage involved increases the effective cost of the use of such bands.

As an alternative to elastic bands it is known to use wire clips, the ends of which are squeezed or wound together. However, such devices also suffer from unnecessary wastage, and are relatively expensive.

Wire clips are also often used to bind together the neck of a sack (e.g. of potatoes) after the neck has been closed, the ends of the clip being wound together to maintain the neck closed.

Tape dispensers are also known which can be used to dispense a required length of adhesive tape. Many of the varieties of such dispensers are designed to be static, e.g. they are located at a shop checkout of the like for the banding of the neck of a plastic bag. Other dispensers are designed to be portable, as for example are the tape dispensers adapted to dispense tape to connect together and seal the flaps on a cardboard box.

### SUMMARY OF THE INVENTION

It is an aim of the present invention to provide a tape dispenser which can be used to dispense tape for the securing together of numbers of produce, so as to replace the above-mentioned elastic bands. In addition, it is desired that the dispenser offer advantages of unit cost and ease and speed of use over the known wire clips and bands.

According to one aspect of the invention there is provided a tape dispenser having a housing adapted to locate a spool of tape, the housing having an opening through which the tape can pass and a blade against which the tape can be pressed so as to be severed, the housing being formed from two housing parts which are retained together by a removable handle.

According to another aspect of the invention there is provided a tape dispenser having a housing adapted to locate a spool of tape, and a handle connected to the housing, the housing having an opening through which the tape can pass and a blade against which the tape can be pressed so as to be severed, characterised in that the housing is substantially waterproof.

The provision of a substantially waterproof housing will permit the dispenser to be used outdoors, for example in the field, without the tape becoming wet, and will also allow the dispenser to be used to bind produce which might itself be wet (having been washed in the pack house for example) without the tape becoming wet inadvertently.

By “substantially waterproof” is meant the ability to prevent the ingress of significant quantities of water. Thus, it is not intended that the housing can prevent the ingress of water if it is totally submerged since it necessarily has an opening for the tape to pass through; however, the tape located within the housing will be maintained dry provided the user takes certain limited precautions during use of the dispenser.

Preferably, the handle projects from the housing substantially parallel to the axis of the tape spool. The provision of such a handle position allows the dispenser to be used to bind articles without either the need for the user to remove his hand from the handle or to pass his hand around the end of the articles, i.e. the user can bind long articles in one movement by manipulating the handle and his wrist and by permitting the handle to twist in his hand.

Preferably also the handle is substantially co-axial with the axis of the spool.

Desirably the housing is of cam formation, with a substantially circular section and an elongated nose section. Preferably the nose section carries the blade.

Usefully there is a number of openings for the tape, the user selecting the opening most suited to binding his articles and the prevailing conditions. Thus, if the produce is wet it may be necessary for the opening to be some distance from the blade so as to provide a longer free tape length so that the tape can for example be gripped by the thumb of the user and held in contact with the produce. When the produce is dry it will be possible for the opening to be closer to the blade so that the free tape length is shorter. Notwithstanding the above considerations, however, the free tape length should not be so great as to encourage entanglement of the free tape.

Preferably the housing comprises two separable parts, the parts being separable to permit replacement of the tape spool. Usefully the parts are identical and so can be manufactured on a common moulding tool.

Desirably, the two parts of the housing are held together by a part of the handle, and the handle is removable to permit separation of the housing parts.

When using the dispenser, the free length of tape will be brought into contact with the produce so as to adhere thereto and the dispenser will be manipulated by the user so as to pass around the produce as further tape is pulled from the dispenser and passed through the opening. When the tape has been wound around the produce a newly exposed length of tape can be adhered to the existing tape. Thus, it is recognised that the tape should be adhered to itself rather than to the produce, which will lead to greater control of the binding process, particularly if the produce is wet. If the produce is so wet that the free run of tape will not initially adhere thereto, the free end of the tape can be gripped by a finger or thumb of the user whilst the tape is bound around the produce and the newly exposed length of tape can be adhered to the existing tape.

Desirably the tape is of PVC or vinyl and has adhesive pre-applied to one side thereof, since if used as intended the tape will be brought into contact with the produce, if the produce is for human consumption it will be necessary for the tape and adhesive to meet the applicable food hygiene standards. A tape which is understood to be suitable is that presently used for the binding of bags of mass-produced bread.

Preferably the housing can locate a printer or marker which can print or otherwise mark a date or other identifying material onto the tape as it is dispensed.

### BRIEF DESCRIPTION OF THE DRAWINGS

The invention will now be described, by way of example, with reference to the accompanying drawings, in which:

FIG. 1 is a side view of a first embodiment of tape dispenser according to the invention;

FIG. 2 is a partial view of the blade area of the housing of the dispenser of FIG. 1;

FIG. 3 is a sectional view of the dispenser as in FIG. 1, with the handle removed;

FIG. 4 is an end view of the handle of the dispenser;

FIG. 5 is a side view of the handle;

FIG. 6 is a view of one housing part of a second embodiment of tape dispenser according to the invention; and

FIG. 7 is an enlarged view of an opening in the housing of the tape dispenser of FIG. 6.

### DESCRIPTION OF THE PREFERRED EMBODIMENTS

The tape dispenser 10 comprises a housing 12 and a handle 14. The housing 12 is made up of two similar parts 16 and 18, which clip together to provide a substantially water-tight seal at the joint 20. The housing parts 16 and 18 are of plastic material, and as is well-known with plastics housings the mouldings can be identical and produced on the same tool, the housing parts having complementary lips and recesses (not shown) adjacent to the joint 20.

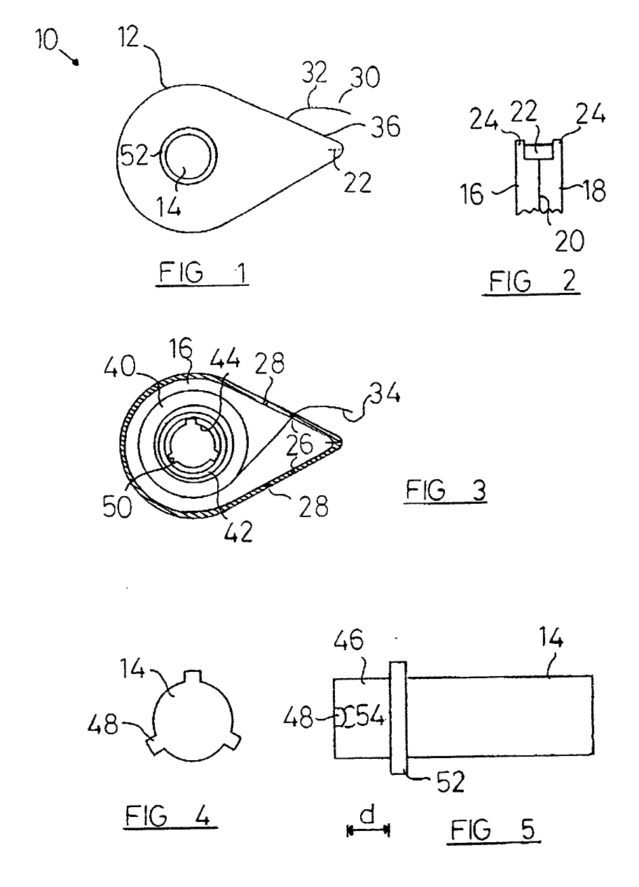

The housing parts 16, 18 mount a blade 22; as is better seen in FIG. 2 the blade is located between walls 24 of the respective housing parts 16, 18, which walls 24 provide protection for the blade, i.e. the walls 24 effectively prevent the inadvertent contact of the user's fingers with the blade 22.

The housing has an opening 26 (FIG. 3) through which the tape, 30 can pass. Between uses of the dispenser to bind successive bundles of produce there is a free length of tape 30 outside of the housing as shown in FIGS. 1 and 3, the free length of tape substantially equalling the distance from the opening 26 to the blade 22.

The surface 32 of the tape 30 has adhesive applied thereto, so that in use it is the surface 32 which is brought into contact with the produce. Notwithstanding that the surface. 34 of the tape 30 does not have adhesive applied thereto, in practice the free length of tape 30 will likely self-adhere to the housing 12, with the surface 34 in contact with the surface 36 of the housing. This self-adherence is believed, to arise from electrostatic activity of the tape, and can be enhanced by adhering another length of tape to the surface 36. Thus, in use, the free length of tape 30 is not likely to lie away from the housing (as is shown for clarity in FIGS. 1 and 3) but is likely to be in contact with the surface 36; whilst in contact with the surface 36 it is not likely to become entanged, and is suitably located for adherence to a subsequent bundle of produce.

The handle 14 projects from the side of the housing 12, and as shown in FIG. 3 is substantially coaxial with the tape spool 40. As shown in FIG. 3, the tape spool 40 is of slightly larger internal diameter than the outer diameter of a boss 42 which surrounds aperture 44 in the housing 16 (a corresponding boss 42 and aperture 44 is provided in the housing 18). Accordingly, the spool 40 is free to move laterally a small distance relative to the boss 42. In alternative embodiments the internal diameter of the spool 40 is substantally identical to the outer diameter of the boss so that the spool is substantially located against relative lateral movement.

As also shown in FIG. 3, the housing 12 has two openings 26 through which the tape 30 can pass, the two openings being present because of the identical nature of the housing parts 16, 18. In other embodiments only one opening 26 is provided, i.e. the housings 16, 18 are not identical.

A second pair of openings 28 are also provided, which openings 28 are further from the blade 22 than the respective openings 26. The provision of second openings 28 is so that the free length of tape can be varied to suit the prevailing conditions and the produce being bound, as necessary, e.g. a longer free length of tape can be provided if the produce is wet.

As described above the housing parts 16, 18 each have a central boss 42 within which is located an aperture 44 for receiving a part of the handle 14, specifically the part 46. The part 46 carries three lugs 48 which can be passed through correspondingly shaped cut-outs 50 in the housing parts 16, 18. In this embodiment the three lugs 48 are spaced at approximately 120° apart around the handle part 46. The handle 14 also has a raised ring 52, the ring 52 and lugs 46 being spaced apart by a distance d which corresponds to the thickness of the housing 12. Thus, the two housing parts 16 and 18 when assembled a be held together between the ring 52 and the lugs 48 of the handle part 46.

To assemble the handle 14 to the housing 12 the housing parts 16, 18 are first brought together (with the apertures 44 and the cut-outs 50 aligned. (The housing parts 16 and 18 can have complementary clip formations allowing them to be held semi-securely together before insertion of the handle if desired). The handle part 46 is then passed through the apertures 44 with the lugs 48 passing through the respective cut-outs 50. When the ring 52 abuts the housing part 16 or 18 (as the case may be) the lugs 48 will have passed through the cut-outs 50 in both of the housing parts, and the handle 14 can be rotated so as to move the lugs 48 out of alignment with the cut-outs 50 and so secure the handle 14 to the housing 12.

The lugs 48 have shaped lead-ins 54 which faciliate ease of rotation of the handle 14 relative to the housing 12. The housing parts 16, 18 carry a raised stop (not shown) so as to limit the rotation of the handle relative to the housing to around 40° or so, and define a “locked” position of the handle.

It will be understood that because the housing parts 16 and 18 are identically formed the handle 14 can project to either side thereof. In addition, the form of the handle part 40 allows the handle to be rotated either clockwise or anticlockwise into its locked position. In this way, the device may be used by either a left or right handed person without the risk of the handle becoming inadvertently released from the housing, i.e the user may choose the direction of relative rotation of the handle 14 and housing 12 into the locked position so as to ensure that in use the handle 14 seeks to rotate further in said direction, i.e. against the stop, rather than seeking to return the lugs 48 towards the cut-outs 50.

In use, when a bundle of produce has been bound, the tape dispensed should exceed the perimeter of the bundle, i.e. the ends of the tape can overlap and preferably engage. It is preferred that the surface 32 of the tape engages (and is adhered to) part of the surface 34, rather than to another part of the surface 32. Thus, whilst “front to front” adherence (i.e. surface 32 to another part of surface 32) could be used it has been found that such adherence is relatively easy to overcome, i.e. if the produce shifts the tape can become loose due to the adherence gradually being broken. With “front to rear” adherence (i.e. surface 32 to surface 34) the whole section of adhered tape contributes to the securement and the adherence of the tape cannot gradually be broken down.

It has been found that an experienced user of the tape dispenser can reduce the time taken to bind produce by a considerable amount, perhaps even halving the binding time for some produce. Since the binding procedure is often the slowest operation in the process of harvesting and bundling the produce for delivery to market, it will be recognized that the tape dispenser offers a considerable advantage in such a procedure. One clear advantage is that since the produce is harvested and bundled more rapidly, less of the produce will mature in the field, i.e. more of the produce can be taken to market in its optimum condition.

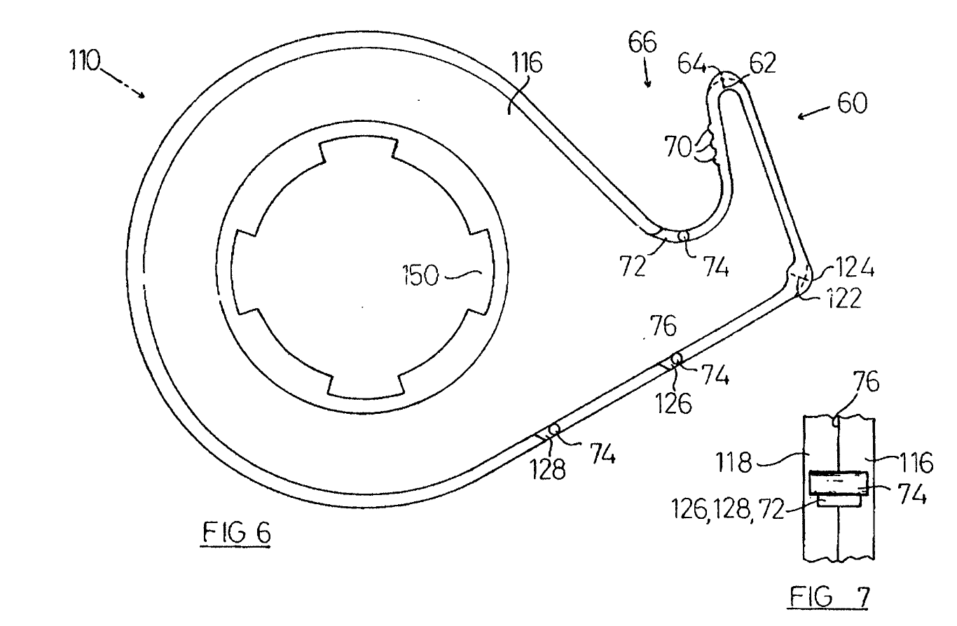

A second embodiment of tape dispenser 110 is shown in FIG. 6. In common with the first embodiment of tape dispenser 10 shown in FIGS. 1-5 the tape dispenser 110 comprises a housing and a handle. The housing is made up of two non-similar parts, only one of which parts 116 is shown in FIG. 6. The housing parts together provide a substantially water-tight volume therebetween. The housing parts mount a blade 122 located between protective walls 124 of the respective housing parts. The housing has two openings 126, 128 through which the tape (not shown) can pass.

In this embodiment, the housing parts have four cut-outs 150 to receive a handle (not shown) having four lugs; it will be understood that the arrangements for connecting the handle to the housing shown in FIGS. 3 and 6 are interchangeable, and more or fewer cut-outs and lugs could be used, as desired.

When it is desired to bind produce, a spool of tape can be placed into the housing part 116, and its free end passed through one of the openings 126 or 128. The housing part 118 (FIG. 7) is subsequently fitted, and the handle inserted and rotated to retain the housing parts 116, 118 together. The tape dispenser 110 can subsequently be used as described in relation to the first embodiment above. The tape dispenser can be made suitable for use by a right- or left-handed person as desired by selecting the side of the housing to which the handle is secured.

The tape dispenser 110 also includes a projection 60 upon which is mounted a second blade 62 (between protective walls 64), the purpose of which is explained below.

Whilst the first embodiment of tape dispenser 10 is suitable for binding together bundles of a large variety of articles, it is believed that it would not always be suitable for more “heavy duty” binding, such as the binding of the neck of a potato sack or the like. With such binding, it is necessary to apply sufficient force to close the neck of the sack prior to and/or during binding. The tape dispenser 110 has been designed for such “heavy duty” binding.

The tape dispenser 110 has a projection 60 which creates a throat 66, with the sides of the throat 66 converging. One side of the throat 66 carries a number of nibs 70, the purpose of which is to increase the “grip” of the dispenser upon the material of the sack, during the binding process.

To use the tape dispenser 110 to bind a potato sack or the like, the housing parts are separated and a spool of tape inserted thereinto so that the tape passes through the opening 72, and lies over the nibs 70 and adjacent the blade 62 (with the adhesive side facing away from the nibs 70 and blade 62); the tape dispenser 110 is subsequently re-assembled. The neck of the sack to be bound is grasped by the free hand of the user and partially compressed. The throat 66 of the tape dispenser 110 is passed around a part of the neck, and rotated clockwise (as drawn) around the neck. As the tape dispenser is so rotated, tape is applied to the neck and at the same time the neck is further compressed into the throat (additional material of the neck entering the left-hand side of the throat (as drawn) whilst the existing material is retained within the throat by the nibs 70). It is expected that by rotating the tape dispenser two or three times around the neck of the sack that the neck of the sack will become fully compressed. A suitably strong tape can be used to ensure that the compressed neck remains compressed (and therefore closed) after it has been released from the throat 66.

It is of course not necessary that all of the neck of the sack be located within the throat at one time, but it is desired that the throat be large enough to locate sufficient of the neck to act to compress the neck during binding. It is therefore expected that a tape dispenser intended to bind the necks of large and/or thick sacks would require a larger throat that a tape dispenser intended to bind the necks of smaller and/or thinner sacks.

When the binding operation has been completed, the tape dispenser can be manipulated to release the throat from around the bound neck, and to place the blade against the free length of tape to sever the tape ready for the next binding operation.

The position of the opening 72 (and of the openings 126 and 128) can of course be varied within suitable limits to suit the particular application, and the precise location is a matter of some design choice. In addition, the position and arrangement of the nibs 70 is open to some design choice, and the rounded nibs 70 could be replaced by a suitable number of sharp teeth, or a roughened surface, as desired to provide the enhanced grip upon the sack material.

FIG. 7 shows a detailed view of an opening 126, 128, 72 (and would also be suitable for an opening 26, 28 of the first embodiment). The housing part 116 includes a peg 74 adjacent each opening, which peg extends beyond the edge 76 of the housing part 116 (which edge lies against the cooperating edge of the other housing part 118 to define the split line in the assembled housing).

The peg 74 spans the opening 126 (etc.) and ensures that the tape does not enter the split line between the two housing parts when in use. The other housing part 118 has a recess to accommodate the peg(s) 74. In another embodiment, one (or more) of the pegs 74 is carried by the housing part 118, and enters a corresponding recess in the housing part 116.

It will be understood that the tape dispenser 10, 110 can be manufactured to accommodate the widest suitable tape (such as a vinyl tape of 12 mm width), and yet will also accommodate narrower tapes. In addition, the thickness (guage) of the tape can be varied to suit the application. It is likely that the dispenser 110 would normally utilise a wider and thicker tape since such tape will usually be required for “heavy duty” binding, whilst the dispenser 10 would normally utilise narrower and thinner tapes.

Clearly, it would be possible to provide a third embodiment of tape dispenser having only a blade 62 (i.e. not having a blade 122—and not requiring openings 126, 128); such a design would be primarily suitable for binding sacks but might also be useful for binding more robust produce.

A major advantage of the tape dispensers is that they produce little or no waste, i.e. an experienced user is unlikely to discard any tape on the floor or ground, and will minimise the length of tape used to bind the produce or the sack.

1. A tape dispenser having a housing adapted to locate a spool of tape, the housing having an opening through which the tape can pass and blade means for cutting the tape, the housing being formed from separable housing parts, the dispenser including a removable handle which can retain the separable housing parts together.

2. A tape dispenser according to claim 1 having an axis about which the spool of tape can rotate, in which the handle projects from the housing substantially parallel to the axis.

3. A tape dispenser according to claim 1 in which the handle is substantially circular in cross-section.

4. A tape dispenser according to claim 1 in which the housing is of cam formation, with a substantially circular section and an elongated nose section.

5. A tape dispenser according to claim 4 in which the nose section carries the blade means.

6. A tape dispenser according to claim 1 in which there is a number of separate openings for the tape.

7. A tape dispenser according to claim 1 in which the housing has a throat means having converging sides, the blade means being located adjacent the throat means.

8. A tape dispenser according to claim 7 in which a part of the throat means carries grip-enhancing means.

9. A tape dispenser having a housing adapted to locate a spool of tape, and a handle connected to the housing, the housing having an opening through which tape can pass and blade means for cutting the tape, the housing being substantially waterproof.

10. A tape dispenser according to claim 9 having an axis about which the spool of tape can rotate, in which the handle projects from the housing substantially parallel to the axis.

11. A tape dispenser according to claim 9 in which the handle is substantially circular in cross-section.

12. A tape dispenser according to claim 9 in which the housing is of cam formation, with a substantially circular section and an elongated nose section.

13. A tape dispenser according to claim 12 in which the nose section carries the blade means.

14. A tape dispenser according to claim 9 in which there is a number of separate openings for the tape.

15. A tape dispenser according to claim 9 in which the housing comprises separable housing parts, the housing parts being separable to permit insertion and removal of the spool of tape.

16. A tape dispenser according to claim 15 in which the housing parts are identically formed.

17. A tape dispenser according to claim 15 in which the housing parts are held together by a part of the handle, and the handle is removable to permit separation of the housing parts.

18. A tape dispenser according to claim 9 in which the housing has a throat means having converging sides, the blade means being located adjacent the throat means.

19. A tape dispenser according to claim 18 in which a part of the throat means carries grip-enhancing means.

20. A tape dispenser according to claim 1 in which the housing can locate printing or marking means which can print the date and/or other identifier onto the tape as it is dispensed.

21. A tape dispenser according to claim 9 in which the housing can locate printing or marking means which can print the date and/or other identifier onto the tape as it is dispensed.
